(19) United States
(12) Patent Application Publication
(10) Pub. No.: US 2005/0242304 A1
(43) Pub. Date: Nov. 3, 2005

(54) Diffuse light pharmaceutical inspection system and process

(76) Inventors: Lynn E. Armbuster, Slatington, PA (US); James P. Ruyak, Bechtelsville, PA (US); Thomas R. Sanko, Mcadoo, PA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/834,697

(22) Filed: Apr. 29, 2004

(51) Int. Cl. G01V 8/00

(52) U.S. Cl. 250/559.16

(57) ABSTRACT

A system and a method for inspecting a plurality of capsule type pharmaceuticals includes a photoelectric sensor, at least one light source disposed adjacent to the photoelectric sensor, and a capsule receiving member including a plurality of capsule receiving orifices, the capsule receiving member being disposed between the photoelectric sensor and the at least one light source wherein the at least one light source is configured to diffuse light through a plurality of the capsule receiving orifices, and wherein the photoelectric sensor is configured to analyze light diffused through the plurality of capsule receiving orifices.

### BACKGROUND

Pharmaceuticals of a capsule type form ideally include both a capsule body having a smooth outer surface to aid in oral consumption and accurate dosages of a drug component contained within the capsule body for effective medication of a user. If a capsule type pharmaceutical does not exhibit both of these two characteristics, a consumer may be unable to ingest the desired medication or suffer a number of undesirable side effects. Consequently, quality control is of heightened importance.

Traditionally, quality control in the pharmaceutical industry has related to the type and purity of capsule ingredients. When manufacturing a large quantity of capsule type pharmaceuticals, however, quality control also relates to the elimination of empty or partially filled capsules. Traditionally, inspection methods for detecting defects in the formation of capsules or other pharmaceuticals primarily include manual inspection, which can be slow, expensive, and subject to operator error. Thus, automated vision systems for quality control are extremely desirable.

More recently, automated vision systems have been developed to detect defects in the formation of the capsule bodies of capsule type pharmaceuticals. These recent automated vision systems reflect light off of each individual capsule body formed to inspect the surface of the body for defects or signs of impurities. While these traditional methods are effective for detecting surface impurities or defects, the requirement of inspecting the surface of each independent capsule body is very time intensive and does not allow for effective inspection of its internal structure.

Additionally, when traditional automated vision systems detect a defect in an identified pharmaceutical, the identified pharmaceutical is typically discarded. However, this practice of discarding every pharmaceutical that is identified as defective is highly expensive and produces a large amount of un-useable product. Moreover, many identified defects could be easily remedied if presented to a manufacturer for remedial actions.

### SUMMARY

An exemplary system for inspecting a plurality of capsule type pharmaceuticals includes a photoelectric sensor, at least one light source disposed adjacent to the photoelectric sensor, and a capsule receiving member including a plurality of medication receiving orifices, the capsule receiving member being disposed between the photoelectric sensor and the at least one light source, wherein the at least one light source is configured to diffuse light through a plurality of the capsule receiving orifices, and wherein the photoelectric sensor is configured to analyze light diffused through the plurality of capsule receiving orifices.

Similarly, an exemplary process for identifying defective pharmaceuticals includes illuminating a first surface of a pharmaceutical receiving member, the pharmaceutical receiving member having a first and second surface including a plurality of pharmaceutical receiving orifices that extend from the first surface to the second surface, and imaging the second surface of the pharmaceutical receiving member with a photoelectric sensor to detect defective pharmaceuticals.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a frontal view of a diffuse light pharmaceutical inspection system, according to a first exemplary embodiment.

FIG. 2 is a side view of a diffuse light pharmaceutical inspection system, according to the first exemplary embodiment.

FIG. 3 is a top view illustrating a load ring fixture and associated inspection light, according to the first exemplary embodiment.

FIG. 4 is a cut away side view illustrating a load ring fixture and associated inspection light, according to the first exemplary embodiment.

FIG. 5 is a cut away top view of a pharmaceutical inspection system in a home position, according to the first exemplary embodiment.

FIG. 6 is a cut away view of a pharmaceutical inspection system in an inspection position, according to the first exemplary embodiment.

FIG. 7 is a perspective view illustrating a capsule hosting ring, according to the first exemplary embodiment.

FIG. 8 is a cut away side view illustrating the internal components of a capsule hosting ring, according to the first exemplary embodiment.

FIG. 9 is a flow chart illustrating a method for detecting defective pharmaceuticals, according to the first exemplary embodiment.

FIG. 10 is a flow chart illustrating an automatic defect detection method, according to the first exemplary embodiment.

FIG. 11 is a perspective view illustrating an identified defective pharmaceutical, according to the first exemplary embodiment.

FIG. 12 is a top view illustrating a load ring fixture having a plurality of inspection LEDs, according to a second exemplary embodiment.

FIG. 13 is a cut away side view illustrating a load ring fixture having a plurality of inspection LEDs, according to the second exemplary embodiment.

FIG. 14 is a cut away top view illustrating a diffuse light pharmaceutical inspection system in a home position, according to a third exemplary embodiment.

Throughout the drawings, identical reference numbers designate similar, but not necessarily identical, elements.

### DETAILED DESCRIPTION

A number of exemplary systems and methods for rapidly inspecting a plurality of pharmaceutical products for defects are described herein. More specifically, the present exemplary systems and methods incorporate a lighting source in the form of one or more light emitting diodes (LEDs), in conjunction with a photoelectric diffuse light detecting camera, such as a charge couple device (CCD), to broadly analyze a plurality of pharmaceutical products for defects. Once a defect is detected, the present exemplary systems and methods further facilitate identification of, and access to the detected defect.

As used in this specification and in the appended claims, the term “pharmaceutical” is meant to be understood broadly as any medicinal structure or edible casing configured to house a substance related to a medicinal treatment. Similarly, the term “capsule” is meant to be understood both here and in the appended claims as referring to any multiple component pharmaceutical having a partially transparent housing. In both the case of the pharmaceutical and the capsule, the medicinal structure can include an active ingredient for an approved medical treatment or a medical treatment being evaluated or the medicinal structure can include a placebo ingredient used during clinical trials to compare against the medical treatment being evaluated (i.e., a placebo capsule). The term “capsule housing” is meant to be understood broadly as referring to any partially transparent shell or component used to form a capsule. In some embodiments, the capsule may contain two or more capsule housings associated with the substance being housed; and the present apparatus and method may be used to evaluate the final capsule or to evaluate an intermediate structure with less than all of the capsule housings.

The term “charge coupled device” or “CCD” is meant to be understood as referring to any light-sensitive integrated circuit that stores and displays data for an image in such a way that each pixel (picture element) in the image is converted into an electrical charge, the intensity of which is related to a color in the color spectrum.

In the following description, for purposes of explanation, numerous specific details are set forth in order to provide a thorough understanding of the present systems and processes for rapidly inspecting a plurality of pharmaceutical products for defects. It will be apparent, however, to one skilled in the art, that the present systems and processes may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

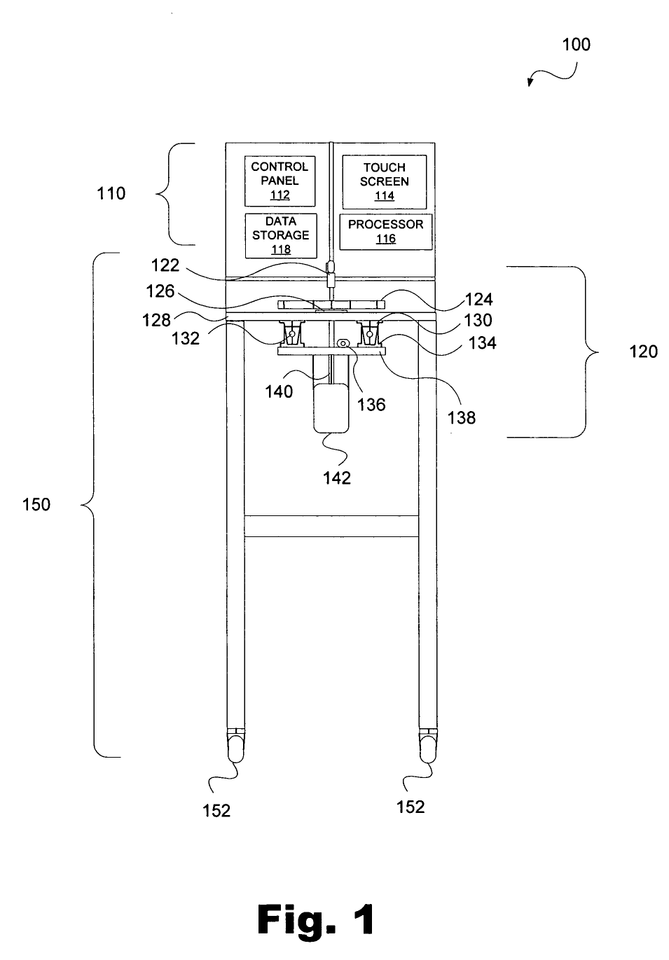

FIG. 1 is a frontal view illustrating a diffuse light pharmaceutical inspection system (100), according to one exemplary embodiment. As illustrated in FIG. 1, the pharmaceutical inspection system (100) may include a user interface (UI) section (110), an inspection unit section (120), and a foundation or transport section (150) having a base (152), shown in the embodiment with wheels or casters (152). As illustrated in the exemplary embodiment of FIG. 1, the UI section (110) of the exemplary pharmaceutical inspection system (100) may include a control panel (112), a touch screen UI (114), a data storage device (118), and a processor (116). Additionally, as illustrated in FIG. 1, the inspection unit section (120) of the pharmaceutical inspection system (100) may include a photoelectric diffuse light detecting camera (122) disposed adjacent to a load ring fixture (124). The load ring fixture (124) is coupled to a drive shaft (140), which in turn is operatively connected to a motor (142). Moreover, an inspection light (126) is disposed adjacent to the load ring fixture (124) opposite the photoelectric diffuse light detecting camera (122). According to one exemplary embodiment illustrated in FIG. 1, the load ring fixture (124), the drive shaft (140), the inspection light (126), and the motor (142) are all moveably coupled to a platform (128) through a plurality of stop supports (130), carriages (134), guides (132), and one or more linear actuators (136), such as a solenoid. Additional functions and details of the individual components of the diffuse light pharmaceutical inspection system (100) illustrated in FIG. 1 will be given below with reference to FIGS. 1 through 8.

As illustrated in FIG. 1, the UI section (110) of one exemplary pharmaceutical inspection system (100) includes both a control panel (112) and a touch screen (114) user interface to facilitate the control and operation of the present diffuse light pharmaceutical inspection system. The control panel (112) may include any number of knobs, switches, dials, and/or displays configured to allow for the adjustment of operational settings of the present pharmaceutical inspection system (100). Similarly, the touch screen (114) may include a pressure sensitive screen configured to be used as an input device. Alternatively, the touch screen (114) portion of the user interface may be replaced by a monitor configured to receive an input from commonly implemented user input devices including, but in no way limited to, a mouse, a keyboard, a keypad, a touchpad, and the like.

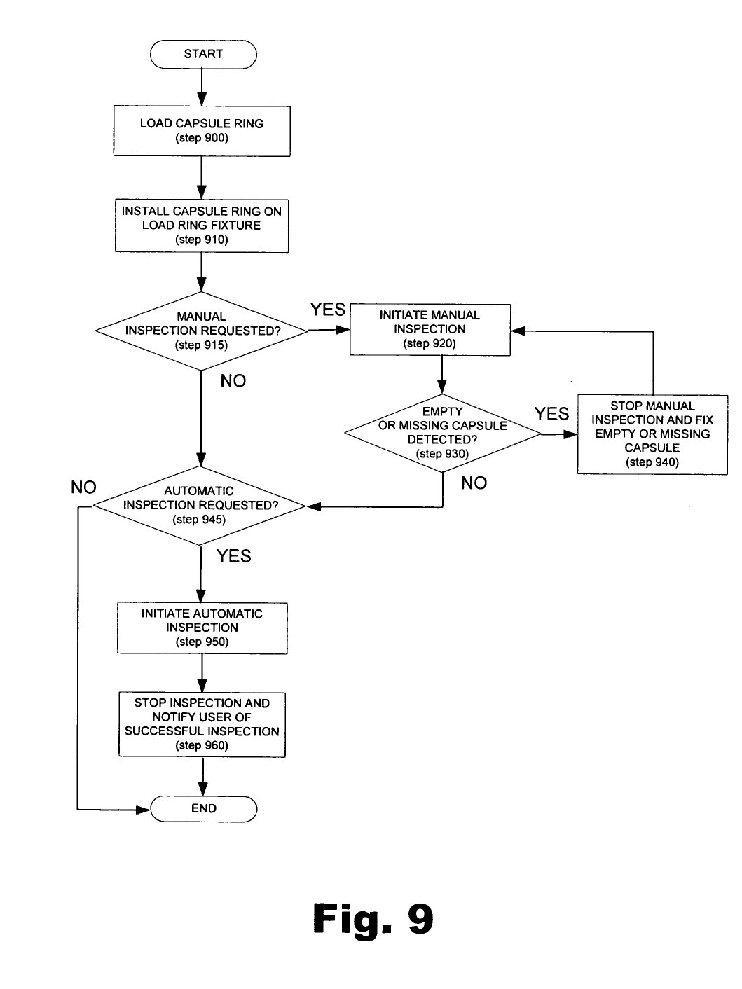

Moreover, as illustrated in FIG. 1, the present UI section (110) includes a processor (116), having firmware hosted thereon, communicatively coupled to a data storage device (118). According to one exemplary embodiment illustrated in FIG. 1, the control panel (112) and the touch screen (114) of the UI section (110) are communicatively coupled to the processor (116) hosting the firmware. During operation, the processor (116), and consequently the firmware, controls the function of the pharmaceutical inspection system (100) and records the detection of defective pharmaceuticals in the data storage device (118). By keeping a record or a log of the frequency and detection of defective pharmaceuticals, the operation of the present system may be enhanced through a number of known quality control procedures. The methods performed by the firmware allow for an inexpensive, yet accurate and relatively fast inspection of pharmaceuticals, as will be explained in further detail below with reference to FIGS. 9 through 11.

Continuing with reference to FIG. 1, the UI section (110) of the pharmaceutical inspection system (100) is communicatively coupled to a number of components that make up the pharmaceutical inspection unit (120). According to one exemplary embodiment, the UI section (110) of the pharmaceutical inspection system (100) is communicatively coupled to the photoelectric camera (122), the motor (142), and the linear actuator (136) of the inspection unit section (120).

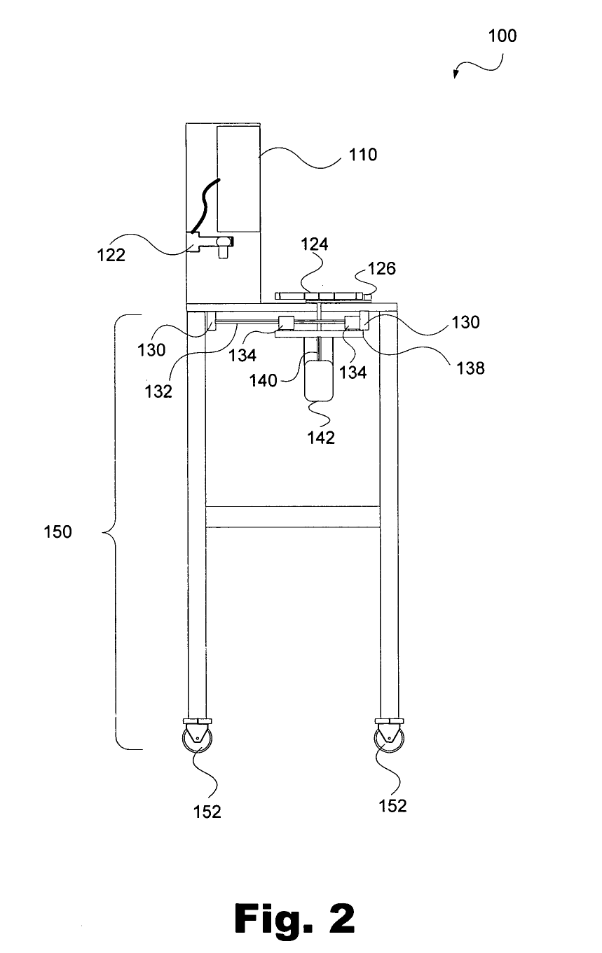

FIG. 2 further illustrates the inspection unit section (120; FIG. 1) of the present pharmaceutical inspection system (100), according to one exemplary embodiment. As illustrated in FIG. 2, the inspection unit (120; FIG. 1) includes a photoelectric camera (122) or sensor communicatively coupled to the UI section (110). A load ring fixture (124) and an inspection light (126) are disposed adjacent to the photoelectric camera (122) on a drive shaft (140) that is coupled to a motor (142). The motor (142), and subsequently the load ring fixture (124) and inspection light (126), are movably coupled to a base (138). The moveable base (138) supports the motor (142) and its associated components and may be controllably translated by one or more linear actuators (136; FIG. 1) in conjunction with a plurality of carriages (134) operating on one or more guides (132). Additionally, a plurality of stop supports (130) couples the base (138) to the foundation portion (150) of the present system. While the present exemplary pharmaceutical inspection system (100) is describe in the context of incorporating a single linear actuator (136; FIG. 1) to selectively translate the motor (142) and its associated components along a single axis, any number of actuators may be incorporated to selectively translate the motor and its associated components in a plurality of directions or to any number of positions.

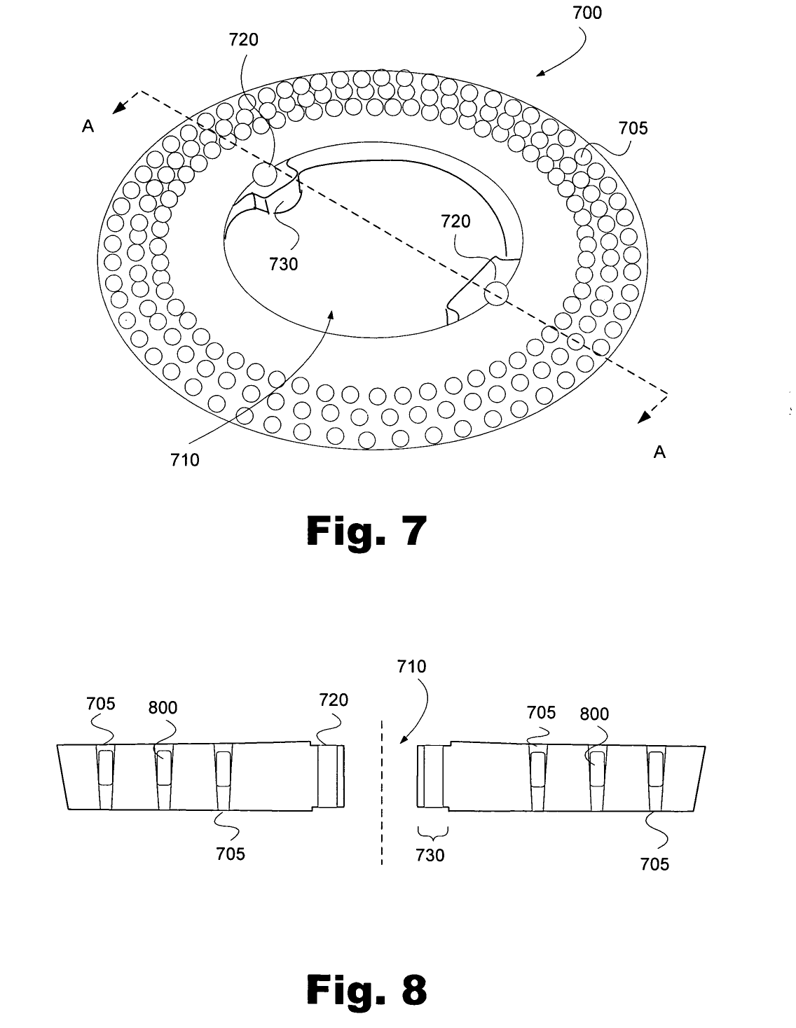

According to one exemplary embodiment, the photoelectric camera (122) illustrated in FIG. 2 is configured to detect a light diffusing through orifices formed in a capsule hosting ring (700; FIG. 7), such as that illustrated in FIG. 7 below. According to one exemplary embodiment, the photoelectric detection camera (122) is configured to image a designated area of a capsule hosting ring (700; FIG. 7) and store the data from the image into a data storage device (118; FIG. 1) by way of the work of processor (116; FIG. 1) in such a way that each image pixel is converted into an electrical charge, the intensity of which is related to a color in the color spectrum. An overall intensity of each image based on the collection of pixels making up the image may then be compared to a threshold value to identify areas of interest that vary from an ideal amount of diffused light by an established threshold quantity. According to one exemplary embodiment, an initial light calibration intensity is associated with the photoelectric detection camera (122). Such initial light calibration intensity may be measured by imaging capsules of the type intended to be tested which have been examined and determined to be free of defects. The initial calibration intensity may then be used by the present pharmaceutical inspection system (100) as a baseline intensity value when newly turned on or reused after a period of inactivity. Accordingly, images collected by the photoelectric detection camera (122) are compared to the calibration intensity. If the intensity or color of the diffused light collected by the photoelectric detection camera (122) varies from the baseline calibration intensity by an established tolerance quantity, a defect is signaled and remedial actions may be taken as explained in further detail below. The established tolerance quantity may be instituted, according to one exemplary embodiment, through the imaging of multiple capsules having some variation in the pattern of light detected, but which have been examined and determined to be free of defects with respect to the purposes for which the capsules will be used. In some embodiments, the number of capsules being imaged to establish the tolerance quantity is relatively large; but subsequently, the initial calibration intensity can be established by imaging one or a limited number of capsules.

The present pharmaceutical imaging system (100) uses the photoelectric detection camera (122) to image multiple orifices in a capsule hosting ring (700; FIG. 7) using diffused light. The use of diffused light allows defects to be rapidly and readily identified. By way of example, if an empty capsule housing is disposed in a capsule hosting ring (700; FIG. 7), light will readily diffuse through the capsule housing and be readily detected by the photoelectric detection camera (122). Similarly, holes, blemishes, erroneous capsule housing color, or other surface defects in the capsule housing will affect the diffusion of light there through and may be detected by the photoelectric detection camera (122). Additionally, the present photoelectric detection camera (122) is sufficiently sensitive to detect variations in the intensity of diffused light passing through a capsule housing based on the quantity of medication disposed within the capsule housing. Consequently, the present photoelectric camera (122) may use diffused light to detect capsules that are not properly filled with sufficient medication. Depending upon the sensitivity of the system and how the established tolerance quantity is set, the apparatus and method of the present invention can be used to detect a range of defect types or can be used to detect only empty capsules or to detect only capsules which are empty or have relatively gross defects. According to one exemplary embodiment, the photoelectric camera (122) incorporated by the present pharmaceutical inspection system (100) may be any diffuse light detecting photoelectric sensor including, but in no way limited to, a CCD camera, fiber optic fibers, lenses, mirrors, prisms, and the like.

FIG. 3 is a more detailed view of the region associated with a load ring fixture (124) and an inspection light (126) and their relationship to a motor (142) and a drive shaft (140). The load ring fixture (124) includes a ring securing member (300) having an interference extrusion (310) and a plurality of fastener receptor orifices (320) formed therein. Additionally, the drive shaft (140) is coupled to the rotational center of the load ring fixture (124). The ring securing member (300) is configured to receive and securely couple a capsule hosting ring (700; FIG. 7), such as that illustrated in FIG. 7 below, or any other pharmaceutical carrying device during an inspection process. The fastener receptor orifices (320) aid in coupling a capsule hosting ring (700; FIG. 7) or other pharmaceutical carrying device by receiving a threaded or other type fastener. Moreover, the interference extrusion (310) formed in the ring securing member (300) aids in the coupling of a ring or other pharmaceutical carrying device by centering the pharmaceutical carrying device onto the ring securing member while providing interference to prevent any slipping of a pharmaceutical hosting device once coupled to the ring securing member.

FIG. 3 also illustrates the inspection light component (126) associated with the load ring fixture (124). According to one exemplary embodiment, the inspection light component (126) includes a lighting member (340) having one or more lighting sources such as a light emitting diode (330) or an LED disposed therein. Additionally, an indication mark (350) is disposed in the inspection light component (126) in line with the LED (330) or other light source, according to one exemplary embodiment. While any number of light sources may be incorporated into the present system and method, the present exemplary pharmaceutical inspection system (100) includes a white light emitting LED (330) in order to add versatility to the inspection system (100). More specifically, according to one exemplary embodiment, pharmaceutical capsules are manufactured in a number of colors, each color exhibiting a different diffusivity, depending on the color of the light source. In fact, a number of capsule colors will not permit some colors of light to be sufficiently diffused to allow meaningful inspection by the photoelectric detection camera (122; FIG. 2). However, a white light emitting LED will allow for pharmaceutical testing of pharmaceutical capsules regardless of the capsule color used, since at least select wavelengths of the emitted white light should be selectively diffused even if other wavelengths are reflected based on capsule color.

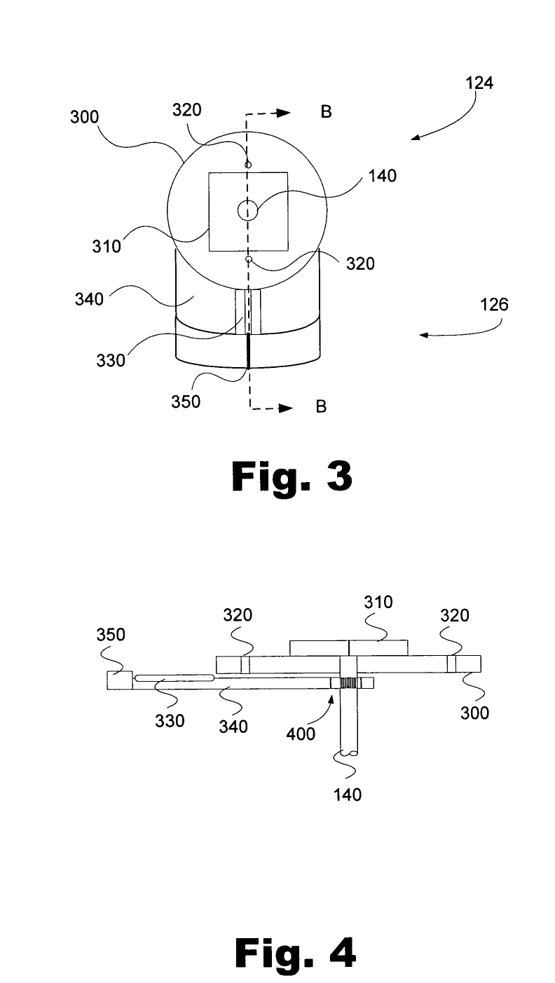

As illustrated in the cut away side view of the load ring fixture and associated inspection light presented in FIG. 4, the ring securing member (300) is coupled to the drive shaft (140) which is in turn coupled to a motor (142; FIG. 2). According to this exemplary embodiment, the motor (142; FIG. 2) may be controllably operated by the UI section (110; FIG. 1) to govern the rotational speed and angular position of the drive shaft (140) and the ring securing member (300). Consequently, the ring securing member (300) and any pharmaceutical hosting device disposed thereon may be controllably positioned during inspection.

Moreover, as illustrated in FIG. 4, a selective shaft coupler (400) may be formed on the lighting member (340) where it associates with the drive shaft (140). According to one exemplary embodiment, the selective shaft coupler (400) may be selectively engaged to couple the drive shaft (140). According to this exemplary embodiment, when the selective shaft coupler (400) is engaged to couple the drive shaft (140), the lighting member (340), the white light emitting LED (330), the indication mark (350), and the ring securing wheel (300) will all be rotated with the same angular velocity. According to this exemplary embodiment, when a defective pharmaceutical is sensed by the inspection unit (120; FIG. 1), the selective shaft coupler may be engaged allowing the white light emitting LED (330) to remain adjacent to the identified pharmaceutical location as the load ring fixture is further manipulated for the viewing and identification convenience of a user, as will be explained in further detail below with reference to FIGS. 9 through 11.

Returning again to FIG. 2, the load ring fixture (124), the inspection light component (126), and the motor (142) are all coupled to a base (138). In turn, the base (138) is moveably coupled to the present pharmaceutical inspection system (100) through a plurality of carriages (134) slideably coupled to a number of guides (132) disposed between stop supports (130). According to the exemplary embodiment illustrated in FIG. 2, as the base (138) is slideably translated, the load ring fixture (124) and the inspection light (126) are also translated with respect to the photoelectric detection camera (122).

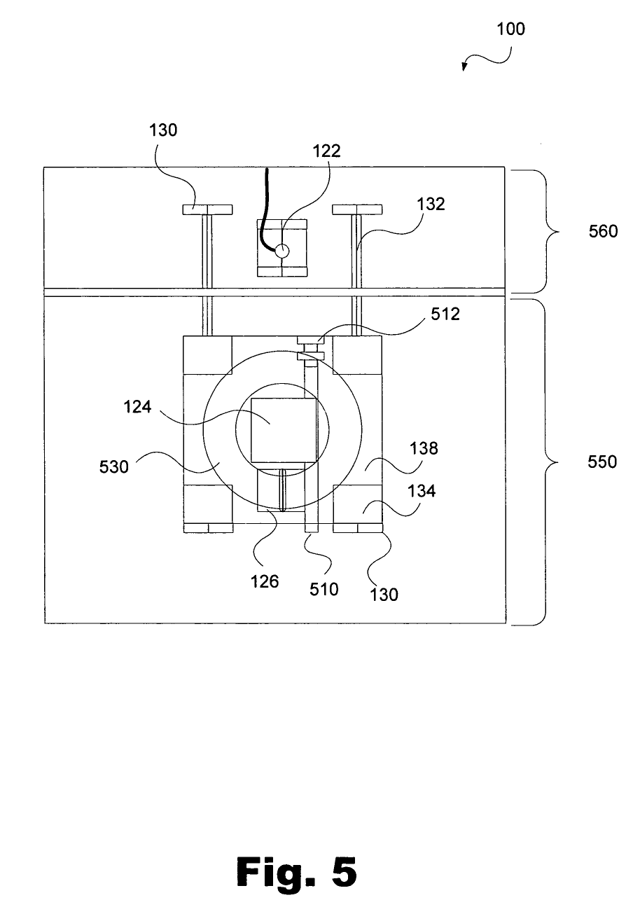

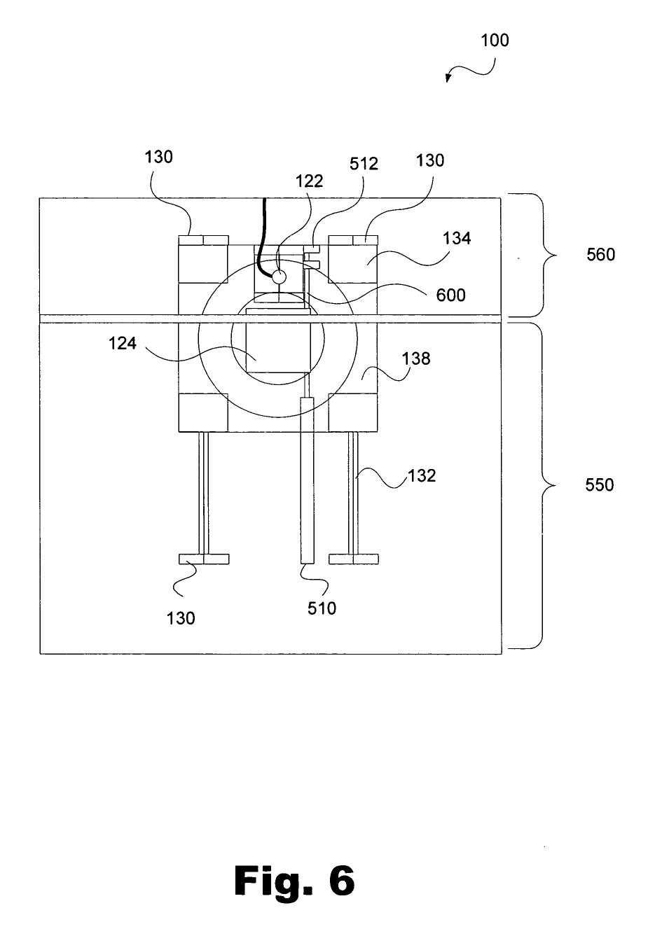

FIGS. 5 and 6 further illustrate the positioning components of the present pharmaceutical inspection system (100), according to one exemplary embodiment. As illustrated in FIG. 5, an exemplary inspection system is illustrated in a “home position” which facilitates inspection of the load ring fixture (124) by a user. As shown, the base (138), the load ring fixture (124), the inspection light component (126), and the carriage components (134) are retracted from the photoelectric camera (122) against a plurality of the stop supports (130). Consequently, the above-mentioned components are in a user accessible portion (550) of the pharmaceutical inspection system (100) where a user may readily access the load ring fixture (124) and any associated components without the obstruction of the UI section (110; FIG. 1). This allows a user to readily access, inspect, and/or repair identified pharmaceutical defects. According to one exemplary embodiment, the inspection system is placed into the home position by a servo mechanism such as the solenoid (510) illustrated in FIG. 5. According to the exemplary embodiment illustrated in FIG. 5, a first end of the solenoid (510) is coupled to the base (138) by a solenoid couple (512). A second end of the solenoid is coupled to an independent portion of the pharmaceutical inspection system (100). When in the home position, the load ring fixture (124) and the inspection light (126) are retracted from the photoelectric camera (122) to allow a user an unobstructed view and access to any pharmaceutical hosting ring (700; FIG. 7) coupled thereto.

In contrast to FIG. 5, FIG. 6 illustrates the pharmaceutical inspection system (100) in an inspection position. The inspection position places the load ring fixture (124) and its associated components, at least partially, in a restricted access portion (560) of the pharmaceutical inspection system (100) where the UI section (110; FIG. 1) restricts free user access to the independent components of the pharmaceutical inspection system (100). As illustrated in FIG. 6, the load ring fixture (124) and its associated components may be placed into the inspection position by the solenoid (510) actuating the extension of a solenoid extension member (600). According to the exemplary embodiment illustrated in FIG. 6, when the solenoid extension member (600) is actuated, the base (138), the load ring fixture (124), and the inspection light (126) are translated towards the photoelectric camera (122) until a desired portion of the load ring fixture is in optical communication with the photoelectric camera.

According to the exemplary embodiment illustrated in FIG. 6, positioning the inspection system (100) between a home position and an inspection position is facilitated by the stop supports (130). As shown, the carriages (134) translate on the guides (132) until they contact the stop supports (130). Accordingly, the base (138) may be easily translated between the stop supports (130) or between the home position and the inspection position. While the above mentioned exemplary pharmaceutical inspection system (100) is described in the context of a solenoid (510) acting on a carriage (134)/guide (132) system, any number of servo mechanisms may be used to controllably translate the load ring fixture (124) and the inspection light (126) including, but in no way limited to, any number of gears, belts, pulleys, actuators, chains, or motors such as servo motors or stepper motors, configured to precisely and selectivley position the base (138).

FIG. 7 illustrates a pharmaceutical hosting ring (700) according to one exemplary embodiment. As illustrated in FIG. 7, the pharmaceutical hosting ring (700) includes a body having a plurality of capsule orifices (705) formed therein. Additionally, a plurality of securing orifices (720) are formed in the pharmaceutical hosting ring (700) to receive a fastener configured to coupled the pharmaceutical hosting ring to a ring load fixture (124). According to the exemplary embodiment illustrated in FIG. 7, the securing orifices (720) are formed in securing extrusions (730) that extend radially inwardly to a center fixture orifice portion (710) of the pharmaceutical hosting ring (700). By extruding the securing extrusions (730) into the center fixture orifice portion (710) of the pharmaceutical hosting ring (700), the center fixture orifice portion is prevented from being perfectly round, creating an advantageous interference between the pharmaceutical hosting ring and the interference extrusion (310; FIG. 3) of the load ring fixture (124; FIG. 3). While the center fixture portion (710) of the present pharmaceutical hosting ring (700) is illustrated in FIG. 7 as having a substantially circular shape, the center fixture portion of the pharmaceutical ring, and its corresponding interference extrusion (310; FIG. 3), may assume any number of shapes. According to one alternative embodiment, the center fixture portion (710) of the pharmaceutical ring (700) may include an irregular polygonal shape. Additionally, according to the alternative embodiment, the corresponding interference extrusion (310; FIG. 3) of the load ring fixture (124) may include a polygonal shape associated with the shape of the center fixture portion (710). The use of irregular polygonal shapes further generates an advantageous interference between the pharmaceutical hosting ring (700) and the load ring fixture (124; FIG. 3).

FIG. 8 is a cut away view of a pharmaceutical hosting ring (700) essentially identical to the pharmaceutical hosting ring illustrated in FIG. 7, with the slight difference that the capsule orifices (705) illustrated in the pharmaceutical hosting ring of FIG. 8 are not staggered as shown in FIG. 7. Accordingly, the present system and method may be performed with pharmaceutical hosting rings (700) exhibiting any number of capsule orifice (705) configurations. As shown in FIG. 8, the capsule orifices (705) extend through the body of the pharmaceutical hosting ring (700) to allow the diffusion of light originating from a first side of the pharmaceutical hosting ring, through the capsule orifices, to a second side of the ring. According to one exemplary embodiment illustrated in FIG. 8, the capsule orifices (705) may be slightly tapered to facilitate the diffusing light while securely receiving a pharmaceutical capsule housing (800). Additionally, as illustrated in FIG. 8, the securing orifices (720) formed in the securing extrusion (730) extend the width of the pharmaceutical hosting ring (700) to allow a bolt or similar fastener to pass there through. Methods for using the present pharmaceutical inspection unit (100) will now be given in detail below with reference to FIGS. 9 through 11.

Exemplary Implementation and Operation

FIG. 9 is a flow chart illustrating an exemplary method for rapidly inspecting a plurality of pharmaceutical products using a photoelectric camera configured to detect diffuse light, according to one exemplary embodiment. As illustrated in FIG. 9, the present method begins by first loading a capsule hosting ring (700; FIG. 7) with desired capsules and/or pharmaceuticals (step 900). While the capsule hosting ring (700; FIG. 7) may be loaded by any number of methods currently known in the art, according to one exemplary embodiment, the capsule hosting ring (700; FIG. 7) is loaded by first dispensing a pharmaceutical capsule housing (800; FIG. 8) into each capsule receiving orifice (705; FIG. 7). The pharmaceutical capsule housings (800; FIG. 8) may be selectively dispensed into each capsule receiving orifice (705; FIG. 7) by a capsule filling machine. According to one exemplary embodiment, the capsule filling machine transfers pharmaceutical capsule housings into a number of tubes which correspond to the capsule receiving orifices (705; FIG. 7) of the capsule hosting ring (700; FIG. 7). A single capsule housing is then inserted into each capsule receiving orifice (705; FIG. 7) by the capsule filling machine. Once substantially all of the capsule orifices contain a capsule housing (800; FIG. 8) or a portion thereof, powder is backfilled into the capsule housings (800; FIG. 8), followed by the insertion of a desired drug, the powder and drug collectively acting as the medication. According to one exemplary embodiment, the drug is inserted into the capsule housings (800; FIG. 8) by hand using a template. The template is flooded with the desired drug until it passes into the capsule housing (800; FIG. 8) or powder to form the desired medication. Once the desired medication is formed within the capsule housing (800; FIG. 8), a mating member of a capsule housing is then joined with the filled capsule housing to complete the formation of the capsule.

Once the capsule hosting ring (700; FIG. 7) has been at least partially loaded, the capsule hosting ring may then be installed onto the load ring fixture (step 910) of the present pharmaceutical inspection system (100; FIG. 1). Using the previously mentioned fastener components, the capsule hosting ring (700; FIG. 7) may be coupled to the load ring fixture (124; FIG. 1). More specifically, according to one exemplary embodiment, the capsule hosting ring (700; FIG. 7) may be coupled to the load ring fixture (124; FIG. 1) by placing the interference extrusion (310; FIG. 3) through the fixture orifice (710; FIG. 7) of the capsule hosting ring. Additionally, the securing orifices (720; FIG. 7) of the capsule hosting ring (700; FIG. 7) may be concentrically aligned with the fastener receptors (320; FIG. 3) of the load ring fixture (124; FIG. 3). Once aligned, a fastener may be passed through both the fastener receptors (320; FIG. 3) and the securing orifices (720; FIG. 7) to securely couple the capsule hosting ring (700; FIG. 7) onto the load ring fixture (124; FIG. 3).

When the capsule hosting ring (700; FIG. 7) is installed onto the load ring fixture (124; FIG. 3), a determination is made as to whether a manual inspection is desired (step 915). If a manual inspection is desired (YES, step 915), a manual inspection may be performed (step 920) on the loaded capsule hosting ring (700; FIG. 7). According to one exemplary embodiment, the manual inspection includes an operator standing over the loaded capsule hosting ring (700; FIG. 7), in a home position, as the capsule hosting ring is rotated above the lighting member (340: FIG. 3). As the manual inspection is performed (step 920), the user interface (110; FIG. 1) is accessed and used to initiate a rotation of the capsule hosting ring (700; FIG. 7) and to control a lighting of the white light emitting LED (330; FIG. 3) disposed on the lighting member (340; FIG. 3). As the loaded capsule hosting ring (700; FIG. 7) is rotated, the capsule hosting ring may be visually inspected by a user for an irregular amount of light diffusing through one or more of the capsule orifices (705; FIG. 7), indicating an empty or missing capsule (step 930). If sufficient light is diffused through a capsule receiving orifice (705; FIG. 7) to indicate an empty, missing, or partially filled capsule (YES, step 930), the rotation of the capsule hosting ring (700; FIG. 7) may be stopped via the user interface (110; FIG. 1) and the empty, missing, or partially filled capsule may be fixed (step 940). Once the empty or missing capsule is fixed (step 940), the manual inspection can again be initiated using the user interface (step 920). The manual inspection process may be performed until visual inspection no longer manifests an empty or missing capsule (NO, step 930).

Once the manual inspection method has been successfully performed (NO, step 930), or it has been determined that a manual inspection is not desired (NO, step 915), a determination may be made as to whether an automatic inspection is desired (step 945). If an automatic inspection is desired (YES, step 945), the automatic inspection process may be initiated (step 950). According to the exemplary embodiment illustrated in FIG. 9, when the automatic inspection process has concluded, a user is notified of the inspection results (step 960).

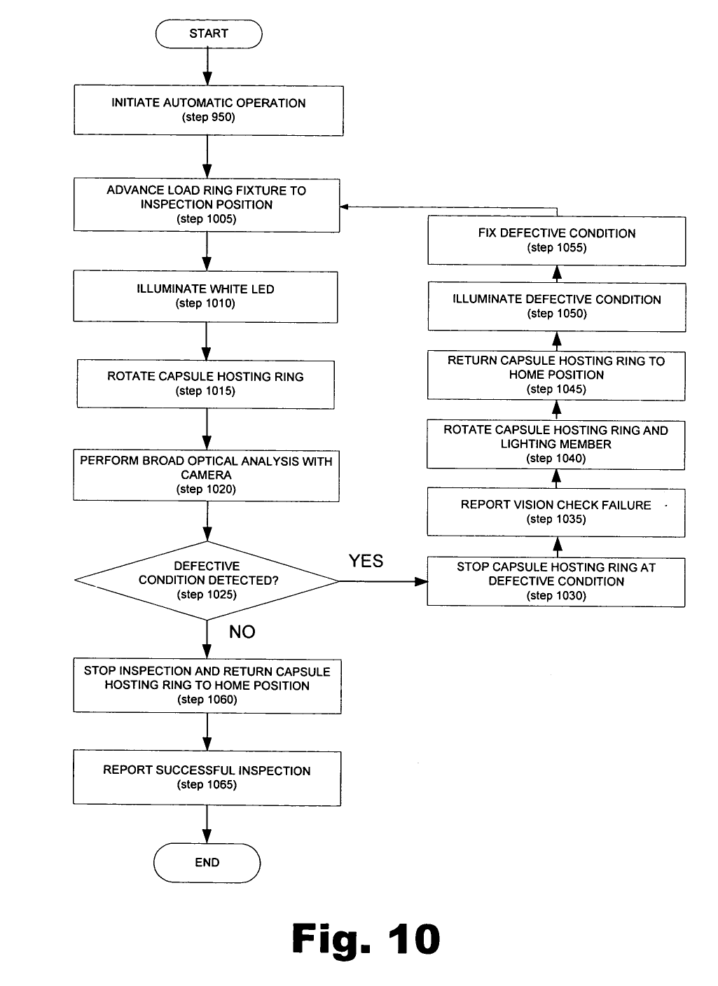

FIG. 10 illustrates one exemplary embodiment for performing the automatic inspection process. As illustrated in FIG. 10, Once the automatic operation is initiated (step 950), the load ring fixture (124; FIG. 3) is advanced to an automatic inspection position. As illustrated in FIG. 6, the automatic inspection position causes the load ring fixture (124) to be advanced adjacent to the photoelectric diffuse light detecting camera (122). Additionally, according to one exemplary embodiment, advancing the load ring fixture (124) into the automatic inspection position includes rotating the lighting member (340; FIG. 3) up to 180 degrees so that the white light emitting LED (330; FIG. 3) is adjacent to the photoelectric diffuse light detecting camera (122).

Returning again to FIG. 10, once in the inspection position (step 1005), the white light LED (330; FIG. 3) is illuminated (step 1010) and the capsule hosting ring (700; FIG. 7) is selectively rotated (step 1015). The combination of the stationary white light LED (330; FIG. 3) disposed adjacent to the photoelectric diffuse light detecting camera (122; FIG. 1), having a capsule hosting ring (700; FIG. 7) selectively rotated there between, allows for a broad and rapid optical analysis to be performed by the photoelectric diffuse light detecting camera (step 1020). Additionally, by analyzing the diffused light, internal as well as external defects may be detected and identified.

According to one exemplary embodiment, the stationary white light LED (330; FIG. 3) and the photoelectric diffuse light detecting camera (122; FIG. 1) may each have a window large enough to allow an optical inspection to be performed on any number of capsule orifices (705; FIG. 7). For example, the white light LED (330; FIG. 3) and the photoelectric diffuse light detecting camera (122; FIG. 2) may be configured to perform optical inspection on a single orifice, a row of orifices, or multiple rows of orifices, depending on the intensity of the light emitted by the white light LED and the sensitivity and viewable area of the photoelectric diffuse light detecting camera.

The broad optical analysis is performed by illuminating a first side of the capsule hosing ring (700; FIG. 7) with a white light emitting LED or other light source, imaging a second side of the rotating capsule hosting ring with the diffuse light detecting camera (122; FIG. 1), and analyzing the resulting images for defect indicating conditions (step 1025). According to one exemplary embodiment, the pharmaceutical inspection system (100; FIG. 1) compares a pixel representation of the diffused light emitted from each capsule receiving orifice (705; FIG. 7) with a pixel representation of a standard, properly filled capsule orifice. In one approach, the inspection system (100; FIG. 1) receives the pixel representation of a standard, properly filled capsule orifice by being initially challenged with one or more properly filled capsule orifices (705; FIG. 7) and establishing an acceptable tolerance or baseline. According to this exemplary embodiment, when an area of the pixel representation of the rotating capsule hosting ring (700; FIG. 7) exceeds, by the tolerance amount, the allowable diffused light as established by the properly filled capsule orifice, a defective condition is detected (YES, step 1025), and the capsule hosting ring is stopped with the defective capsule receiving orifice (705; FIG. 7) adjacent to the white light emitting LED (330; FIG. 3) of the inspection light (126; FIG. 3).

When the rotation of the capsule hosting ring (700; FIG. 7) is stopped (step 1030), failure of the automatic inspection is reported (step 1035) to a user via the UI (110; FIG. 1), and to the data storage device (118; FIG. 1) where a log of the defect detections is stored. Such a log can be used to collect data associated with the number of defects detected from each batch of capsules or to collect further data such as: the position of each defect on the capsule hosting ring (700; FIG. 7) or the extent and nature by which the intensity or color of the diffused light collected by the photoelectric detection camera (122; FIG. 1) varied from the baseline calibration intensity and the established tolerance quantity criteria that were set at the time of the measurement and against which the partial capsule was determined to fail. By keeping a log of the defect detections, one or more automatic inspections may be readily analyzed and used to improve quality control of the capsule filling and inspection methods. Additionally, the log of defect detections may be used to evidence compliance with pharmaceutical quality requirements instituted by governmental or other supervisory agencies.

After the capsule hosting ring has been stopped and failure of the inspection has been reported (step 1035), the capsule hosting ring (700; FIG. 7) and the lighting member (340; FIG. 3) may be rotated up to 180 degrees (step 1040) to position the inspection light (126; FIG. 3) and the identified defective capsule receiving orifice (705; FIG. 7) closer to a user position. According to one exemplary embodiment, the synchronized rotation of the capsule hosting ring (700; FIG. 7) and the inspection light (126; FIG. 3) may be accomplished by actuating the selective shaft coupler (400; FIG. 4) of the inspection light component (126; FIG. 3). Actuation of the selective shaft coupler (400; FIG. 4) couples the inspection light (126; FIG. 3) to the drive shaft (140; FIG. 4), facilitating a synchronized rotation of the two components.

After, or in conjunction with the rotation of the capsule hosting ring (700; FIG. 7) and the lighting member (step 1040), the capsule hosting ring is returned to a home position (step 1045) as illustrated in FIG. 5. As shown, the home position returns the load ring fixture (124) and the capsule hosting ring (530) to a user accessible portion (550) of the pharmaceutical inspection system (100), where a user may visually inspect and access the identified defective capsule receiving orifice (705; FIG. 7).

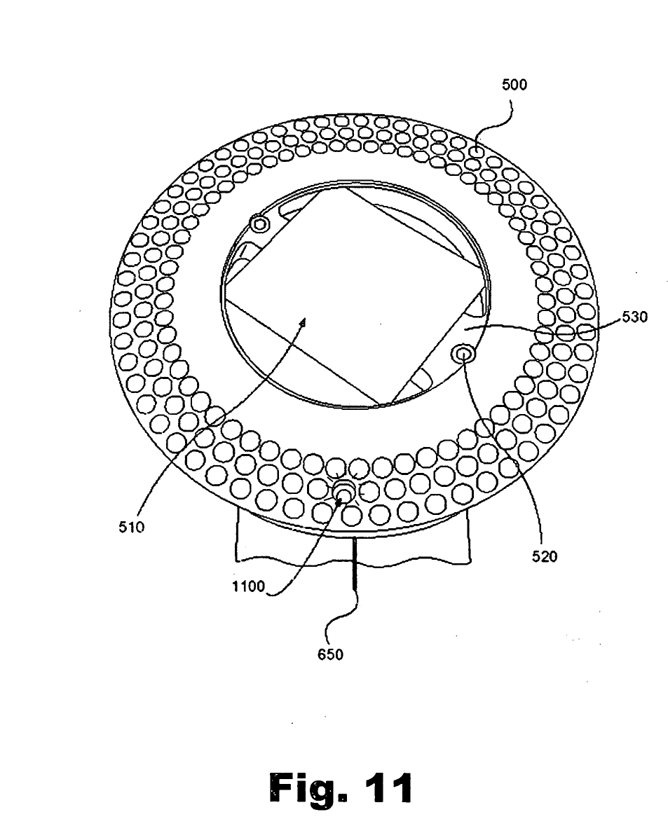

Returning again to the exemplary method illustrated in FIG. 10, once in the home position, the inspection light (126; FIG. 3) is illuminated to highlight the identified defective capsule orifice (step 1050). FIG. 11 further illustrates a highlighted orifice (1100) according to one exemplary embodiment. As illustrated in FIG. 11, when the identified defective capsule orifice (1100) is highlighted by the inspection light (126; FIG. 3), an abnormal amount of light is diffused through the identified defective capsule orifice (1100) and may be viewed by a user. Further, identification of the identified defective capsule orifice (1100) may be facilitated by the indication mark (650) configured to indicate the location of the inspection light (126; FIG. 3) and the identified defective capsule orifice (1100). This allows a user to rapidly identify, inspect, and potentially remedy a defective pharmaceutical.

Returning again to FIG. 10, once the defective capsule orifice is illuminated (step 1050), the user may take steps to fix the defective condition (step 1055) and return the load ring fixture into the inspection position (step 1005) for further imaging.

The above-mentioned automatic imaging methods may be performed until no defective condition is detected by the pharmaceutical inspection system (NO, step 1025). Once imaging of the entire capsule hosting ring (700; FIG. 7) has been performed without detecting an unacceptable amount of diffused light, the automatic inspection operation is stopped and the load ring fixture (124; FIG. 5) is returned to its home position (step 1060) to facilitate removal of the capsule hosting ring (700; FIG. 7) and further processing of the capsules. Additionally, the successful inspection is reported to a user via the UI, and to the data storage device (step 1065).

By imaging a capsule hosting ring (700; FIG. 7) as it passes between a photoelectric diffuse sensing camera (122; FIG. 1) and a white light emitting source, the present systems and methods provide for a rapid and broad analysis of the capsule receiving orifices (705; FIG. 7). More specifically, the sensing and analyzing of diffused light to identify areas of potential defect in a pharmaceutical capsule allows for the imaging of the general surface of the capsule hosting ring for diffused light rather than inspecting each individual pharmaceutical, resulting in increased inspection rates when compared to systems and methods that analyze the surface of each individual capsule receiving orifice (705; FIG. 7) with a reflective light source. Not only does the use of diffused light allow a photoelectric sensor to rapidly detect empty or partially filled capsules, the sensitivity of the photoelectric sensor is such that it may detect surface abnormalities, partially filled capsules, capsule housing color variations, and other defects that may be manifest by slight variations of diffused light. Additionally, by keeping a log of the number of defects sensed by the pharmaceutical inspection system (100), quality control and process refinement may be enhanced.

### ALTERNATIVE EMBODIMENTS

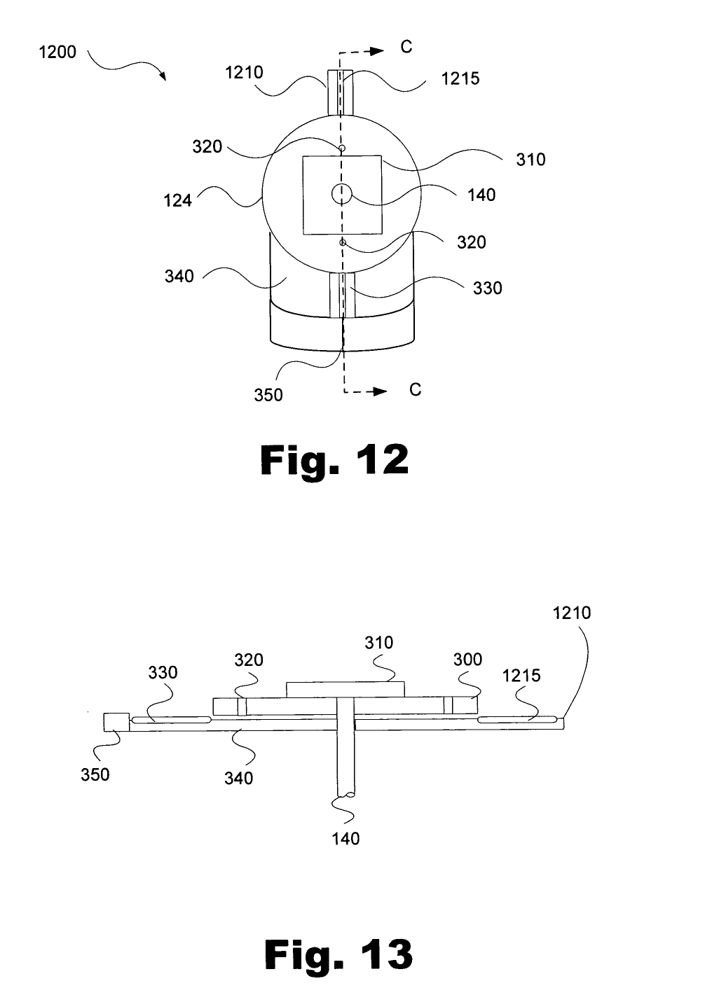

FIG. 12 illustrates a pharmaceutical inspection unit according to an exemplary alternative embodiment. As illustrated in FIG. 12, the pharmaceutical inspection unit (1200) includes a load ring fixture (124), as illustrated above, including a plurality of securing receptors (320) and an interference extrusion (310) coupled to a drive shaft (140). Additionally, the pharmaceutical inspection unit (1200) illustrated in FIG. 12 includes two light sources: a lighting member (340), having a first white light emitting LED (330) and an indication mark (350), as well as an inspection member (1210) having a second white light emitting LED (1215). According to the alternative embodiment illustrated in FIG. 12, the first (330) and second (1215) white light emitting LEDs are disposed on directly opposite sides of the load ring fixture (124). Consequently, the first white light emitting LED (330) associated with the lighting member (340) is configured to highlight an identified capsule receiving orifice (705; FIG. 7) of interest when in the home position, while the second white light emitting LED (1215) is configured to be used in conjunction with the photoelectric diffuse sensing camera (122; FIG. 1) to image the capsule hosting ring (700; FIG. 7) when in the inspection position.

As illustrated in FIG. 13, the lighting member (640) is not rotatably coupled to the drive shaft (140). Consequently, the first (330) and second (1215) white light emitting LEDs are not rotated with respect to the ring securing member (600). However, according to this alternative embodiment, the first (330) and second (1215) white light emitting LEDs are coupled to the base (138; FIG. 1) to allow the first and second white light emitting LEDs to be translated with the inspection unit (1200) between the home and inspection positions. According to this alternative embodiment, when a defective condition is detected by the pharmaceutical inspection system (100; FIG. 1), only the capsule hosting ring (700; FIG. 7) is rotated 180 degrees. This rotation of the capsule hosting ring (700; FIG. 7) transfers an identified capsule receiving orifice (705; FIG. 7) of interest from a position adjacent to the inspection member (1210) having a second white light emitting LED (1215) to the first white light emitting LED (330) and indication mark (350), where the identified capsule receiving orifice of interest may be readily inspected by a user.

In yet another alternative embodiment (not shown), one or both of the first and second white light emitting LEDs may be securely coupled to the platform (128; FIG. 1) of the foundation or transport section (150; FIG. 1) such that they are not translated with the capsule hosting ring (700; FIG. 7). Rather, as the capsule hosting ring (700; FIG. 7) is translated between the home and inspection positions, the capsule hosting ring is positioned adjacent to one of the fixed first and second white light emitting LEDs or other light source.

In contrast to the earlier embodiments illustrated in FIGS. 1 through 11, the alternative embodiment illustrated above incorporate a plurality of light sources, thereby eliminating the function of selectively rotating the light sources. By positioning the first light source directly opposite the second light source, a 180 degree rotation of the capsule hosting ring (700; FIG. 7), as it is translated between the home and inspection positions, will place an identified capsule receiving orifice (705; FIG. 7) of interest adjacent to a light source in the home position, thereby enabling inspection of the capsule receiving orifice.

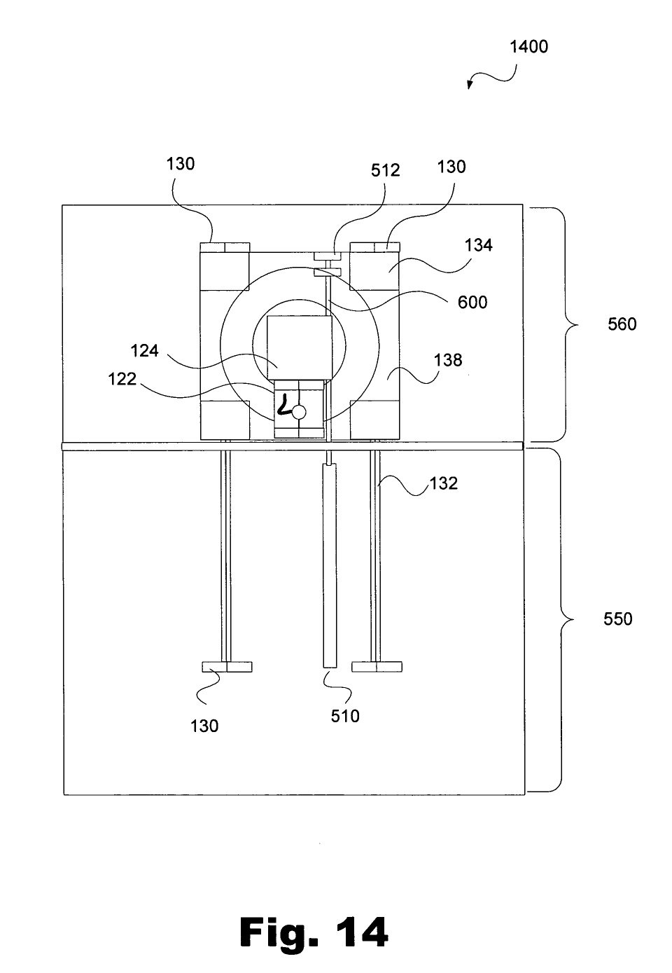

FIG. 14 illustrates yet another alternative embodiment of the present system and method. As illustrated in FIG. 14, the pharmaceutical inspection unit (1400) includes a number of stop supports (130) that are disposed so as to permit the entire base (138) to be disposed with in the restricted access portion (560) of the pharmaceutical inspection unit. According to this exemplary embodiment, the photoelectric camera (122) may be positioned to eliminate the need for superfluous rotation of the load ring fixture (124). Rather, both the photoelectric camera (122) and the user will inspect the load ring fixture (124) from the same relative side. Consequently, when a defective condition is detected during automatic inspection (Yes, step 1025; FIG. 10), the capsule hosting ring may be returned to its home position (step 1045; FIG. 10) located in the user accessible portion (550) of the pharmaceutical inspection unit (1400) without performing a 180 degree rotation of the capsule hosting ring and/or lighting (step 1045; FIG. 10).

In conclusion, the present systems and methods for inspecting pharmaceutical products for defects decreases inspection time while increasing quality control. More specifically, the present systems and methods image diffused light passing through a capsule hosting ring to detect defects both on the surface and within the pharmaceuticals. By focusing on diffused light rather than reflected light, the present system and method may more quickly analyze multiple images searching for a quantity of diffused light that exceeds a threshold value, and consequently indicates a defective pharmaceutical. Additionally, the present systems and methods increase the ability to access a defective pharmaceutical by identifying the defective pharmaceutical and positioning it in a readily accessible location for the user. Moreover, by keeping a log of the detected defects, the present systems and methods provide for increased quality control.

The preceding description has been presented only to illustrate and describe exemplary embodiments of the present systems and methods. It is not intended to be exhaustive or to limit the systems and methods to any precise form disclosed. Many modifications and variations are possible in light of the above teaching. It is intended that the scope of the systems and methods be defined by the following claims.

1. An apparatus for inspecting a pharmaceutical comprising:
a photoelectric sensor; and
at least one light source disposed adjacent to said photoelectric sensor;
wherein said apparatus is configured to detect defects in a pharmaceutical with the photoelectric sensor by sensing light generated from said at least one light source;
wherein the light is diffused through the pharmaceutical.

2. The apparatus of claim 1, further comprising a pharmaceutical receiving member, said pharmaceutical receiving member being disposed between said photoelectric sensor and said at least one light source.

3. The apparatus of claim 1, further comprising:
a fixture configured to couple a pharmaceutical receiving member;
a motor having a drive shaft, wherein said drive shaft is coupled to said fixture; and
a servo mechanism coupled to said fixture, wherein said servo mechanism is configured to selectively translate said fixture between a first and a second position;
wherein said first position is between said photoelectric sensor and said at least one light source; and
wherein said second position is a user accessible position.

4. The apparatus of claim 3, wherein said motor is configured to rotate said fixture when said servo mechanism translates said fixture between said first and said second position.

5. The apparatus of claim 1, further comprising:
a user interface;
wherein said user interface is controllably coupled to said photoelectric sensor and said at least one light source.

6. The apparatus of claim 5, wherein said user interface comprises a memory storage device;
said memory storage device being configured to keep a log of defective pharmaceuticals.

7. The apparatus of claim 1, wherein said photoelectric sensor comprises one of a charge couple device, a fiber optic fiber, a mirror, a prism, or a lens.

8. The apparatus of claim 1, wherein said at least one light source emits white light.

9. The apparatus of claim 8, wherein said at least one light source comprises a light emitting diode.

10. The apparatus of claim 1, wherein said at least one light source comprises:
a plurality of light sources;
wherein at least one of said plurality of light sources emits a white light.

11. An apparatus for inspecting a plurality of pharmaceuticals comprising:
a photoelectric sensor;
at least one light source disposed adjacent to said photoelectric sensor; and
a capsule receiving member including a plurality of capsule receiving orifices, said capsule receiving member being disposed between said photoelectric sensor and said at least one light source;
wherein said at least one light source is configured to diffuse light through a plurality of said capsule receiving orifices; and
wherein said photoelectric sensor is configured to analyze said light diffused through said plurality of capsule receiving orifices.

12. The apparatus of claim 11, further comprising:
a fixture configured to couple said capsule receiving member;
a motor having a drive shaft, wherein said drive shaft is coupled to said fixture; and
a servo mechanism coupled to said fixture, wherein said servo mechanism is configured to selectively translate said fixture between a first and a second position;
wherein said first position is between said photoelectric sensor and said at least one light source; and
wherein said second position is a user accessible position.

13. The apparatus of claim 12, wherein said at least one light source comprises:
a lighting member including a white light emitting source and an indication mark;
wherein said lighting member is selectively coupled to said drive shaft.

14. The apparatus of claim 13, wherein said white light emitting source comprises a white light emitting diode.

15. The apparatus of claim 12, further comprising:
a user interface;
wherein said user interface is controllably coupled to said photoelectric sensor, said at least one light source, said motor, and said servo mechanism.

16. The apparatus of claim 11, wherein said photoelectric sensor comprises one of a charge couple device, a fiber optic fiber, a mirror, a prism, or a lens.

17. The apparatus of claim 11, further comprising a data storage device;
wherein said data storage device is configured to store a log of a detection of defective pharmaceuticals.

18. The apparatus of claim 11, wherein said at least one light source comprises:
a plurality of lighting members;
wherein at least one of said plurality of lighting members comprises a white light emitting diode.

19. The apparatus of claim 11, wherein said photoelectric sensor is configured to:
identify a capsule receiving orifice containing a defective capsule; and
present the defective capsule receiving orifice to a user.

20. The apparatus of claim 19, wherein the defective capsule comprises one of a missing capsule housing, a wrong capsule housing color, a partially filled capsule housing, or a defective capsule housing.

21. The apparatus of claim 19, wherein presenting the capsule receiving orifice to a user comprises:
stopping a rotation of said capsule receiving orifice under said photoelectric sensor; and
transferring the capsule receiving orifice to an inspection position.

22. An apparatus for inspecting a plurality of pharmaceuticals comprising:
a user interface, said user interface including a control panel, a touch screen interface, a data processor, and a data storage device; and
an inspection unit communicatively coupled to said user interface, wherein said inspection unit includes:
a photoelectric sensor configured to detect diffused light;
a white light source disposed adjacent to said photoelectric sensor;
a movable fixture;
a capsule receiving member including a plurality of capsule receiving orifices associated with said capsule receiving member, said capsule receiving member being selectively disposed between said photoelectric sensor and said white light source by said movable fixture;
a motor having a drive shaft, wherein said drive shaft is coupled to said moveable fixture; and
a servo mechanism coupled to said movable fixture, wherein said servo mechanism is configured to selectively translate said movable fixture between a first and a second position;
wherein said white light source is configured to disperse light on a plurality of said capsule receiving orifices; and
wherein said photoelectric sensor is configured to analyze light diffused through said plurality of capsule receiving orifices.

23. The apparatus of claim 22, wherein the first position comprises a location between said photoelectric sensor and said white light source; and
wherein the second position comprises a user accessible position.

24. The apparatus of claim 22, wherein said photoelectric sensor comprises one of a charge couple device, a fiber optic fiber, a mirror, a prism, or a lens.

25. The apparatus of claim 22, wherein said data storage device is configured to store a log of a detection of defective pharmaceuticals.

26. The apparatus of claim 22, comprising a first and a second white light source;
wherein said first white light source is disposed adjacent to said photoelectric sensor; and
wherein said second white light source is disposed in a user accessible location.

27. The apparatus of claim 22, wherein said user interface is configured to:
identify a defective pharmaceutical based on an input from said photoelectric sensor;
stop a rotation of said capsule receiving member under said photoelectric sensor;
translate said capsule receiving member to a user accessible position; and
illuminate the identified defective pharmaceutical.

28. The apparatus of claim 22, wherein the white light source comprises a light emitting diode.

29. A process for identifying defective pharmaceuticals comprising:
illuminating a first surface of a pharmaceutical receiving member, said pharmaceutical receiving member having a first and second surface including a plurality of pharmaceutical receiving orifices that extend from the first surface to the second surface; and
imaging the second surface of said pharmaceutical receiving member with a photoelectric sensor to detect defective pharmaceuticals.

30. The process of claim 29, wherein said imaging the second surface comprises sensing an intensity of diffused light passing through said pharmaceutical receiving orifices to the second surface of said pharmaceutical receiving member.

31. The process of claim 29, further comprising:
identifying a defective pharmaceutical based on an amount of diffused light emitted from a corresponding pharmaceutical receiving orifice; and
presenting the defective pharmaceutical to a user.

32. The process of claim 31, wherein said presenting the defective pharmaceutical to a user comprises:
moving the pharmaceutical receiving member to a user accessible location; and
illuminating the pharmaceutical receiving orifice associated with the identified defective pharmaceutical.

33. The process of claim 32, wherein said moving the pharmaceutical receiving member to a user accessible location comprises:
rotating the pharmaceutical receiving member; and
translating the pharmaceutical receiving member away from the photoelectric sensor.

34. The process of claim 29, wherein said illuminating a first surface of a pharmaceutical receiving member comprises:
disposing a white light source adjacent to the first surface of the pharmaceutical receiving member; and
dispensing a light from the white light source onto the first surface of the pharmaceutical receiving member.

35. The process of claim 29, further comprising optically inspecting light diffused through the pharmaceutical receiving member.

36. A process for identifying defective pharmaceuticals comprising:
translating a pharmaceutical receiving member from a user accessible location to an inspection position between a photoelectric sensor and a white light source, the pharmaceutical receiving member having a first and second surface and a plurality of pharmaceutical containing orifices that extend from the first surface to the second surface;
rotating the pharmaceutical receiving member;
illuminating the first surface of the pharmaceutical receiving member with the white light source;
imaging the second surface of said pharmaceutical receiving member with a photoelectric sensor to detect defective pharmaceuticals;
identifying a defective pharmaceutical; and
presenting the defective pharmaceutical to a user.

37. The process of claim 36, wherein said identifying a defective pharmaceutical comprises:
establishing a threshold diffused light intensity;
analyzing an image of the second surface for a pharmaceutical containing orifice that exceeds said established threshold diffused light intensity; and
identifying a pharmaceutical containing orifice that exceeds said established threshold diffused light intensity as a pharmaceutical containing orifice associated with a defective pharmaceutical.

38. The process of claim 37, wherein said presenting a defective pharmaceutical to a user comprises:
stopping said rotation of the pharmaceutical receiving member;
transferring the pharmaceutical receiving member to a user accessible location; and
illuminating a pharmaceutical containing orifice associated with the defective pharmaceutical.
